(19) United States
(12) Patent Application Publication
(10) Pub. No.: US 2017/0212769 A1
(43) Pub. Date: Jul. 27, 2017

(54) WEARABLE CLOTHING ACCESSORY INCORPORATING AN OPEN COMPUTING PLATFORM

(71) Applicant: Ge Yang, San Ramon, CA (US)

(72) Inventor: Ge Yang, San Ramon, CA (US)

(21) Appl. No.: 15/006,659

(22) Filed: Jan. 26, 2016

(51) Int. Cl. G06F 9/44; H04W 4/22; H04B 7/26; G06F 3/041; G06F 1/26

(52) U.S. Cl. CPC G06F 9/4406; G06F 3/041; G06F 1/26; H04B 7/26; H04W 4/22

(57) ABSTRACT

A clothing or garment accessory incorporating a computing platform being configured to provide a user with a wearable open computing platform. The computing platform includes a multiplicity of conductive threads incorporated in the fabric of the clothing or garment accessory used as power wires, communication wires and connection points. A central processing unit control the functions of units connected to the platform. A display unit senses a touch of a user and display executed software applications. A battery unit supplies power to the central processing unit, the display unit, and other hardware units connected to the central processing unit through the power wires. A preconfigured software app running on the central processing unit provides a user interface operable to control and communicate with the connected hardware units.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF THE INVENTION

One or more embodiments of the invention generally relate to computing systems. More particularly, the invention relates to wearable computing platforms.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, consumer electronics, such as smartphones, are stored on a user's person when not in use. Personal storage, such as pockets or sleeves on clothing, may not securely hold and/or enable easy access for a user's electronic devices. When a user desires to use their electronic device, there may be a chance that the device will be dropped while being retrieved and/or used. Additionally, a user generally must use one or both hands to operate an electronic device.

Electronic devices often may be upgraded with additional features such as sensors and/or modules to improve functionality and/or provide conveniences to a user. Upgrades to electronic devices typically require more electronic hardware to be fitted in a small form factor during manufacturing and typically increase the cost of the electronic device. Modular add-ons to devices may be applied to existing devices, but generally take up a noticeable amount of space and/or may make electronic devices unwieldy.

The following is an example of a specific aspect in the prior art that, while expected to be helpful to further educate the reader as to additional aspects o the prior art, is not to be construed as limited the present invention, or any embodiments thereof, to anything states or implied therein or inferred thereupon. By way of educational background, another aspect of the prior art generally useful to be aware of is that smart garments have been designed to allow for electronic devices to interface with sensors and/or peripherals embedded in the fabric of the garment. More examples of prior arts here?

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A illustrates a front view of an exemplary wearable computing platform, in accordance with an embodiment of the present invention;

FIG. 1B illustrates a back view of an exemplary wearable computing platform, in accordance with an embodiment of the present invention;

FIG. 2 illustrates a soft chip, in accordance with an embodiment of the present invention;

FIG. 3 illustrates an exemplary thermal regulation configuration of a wearable computing platform, in accordance with an embodiment of the present invention;

FIG. 4 illustrates the architecture of an exemplary wearable computing platform, in accordance with an embodiment of the present invention;

FIG. 5 illustrates an exemplary radio unit, in accordance with an embodiment of the present invention;

FIG. 6 illustrates an exemplary display unit, in accordance with an embodiment of the present invention;

FIG. 7 illustrates an exemplary thermal regulation unit, in accordance with an embodiment of the present invention;

FIG. 8 illustrates an exemplary RFID unit, in accordance with an embodiment of the present invention;

FIG. 9 illustrates an exemplary Central Processing Unit, in accordance with an embodiment of the present invention;

FIG. 10 illustrates a block diagram depicting a conventional client/server communication system.

FIG. 11 illustrates an exemplary soft hardware module in accordance with an embodiment of the present invention;

FIG. 12 illustrates the architecture of a simplified example of wearable computing platform in accordance with an embodiment of the present invention.

FIG. 13 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term” substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”, e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, in re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter. Moreover, for any claim of the present invention which claims an embodiment “consisting essentially of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention and variations thereof, relate to wearable computing platforms integrated with garments. In one embodiment of the present invention, a jacket is integrated with a computing platform and hardware modules, including but not limited to ribbon data cable, optical fiber, Ethernet cable, Wi-Fi, Bluetooth, NFC

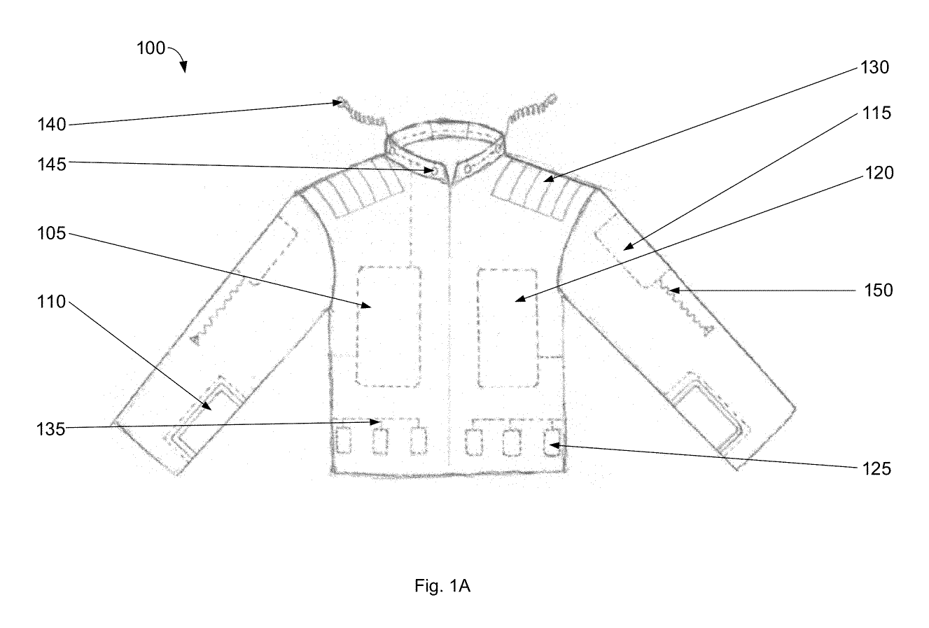

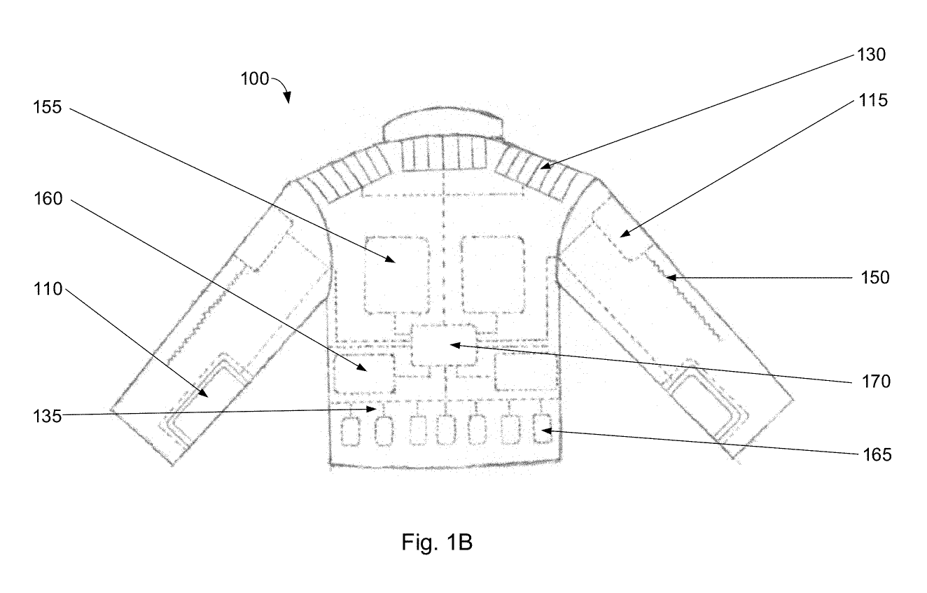

FIG. 1A illustrates a front view of an exemplary wearable clothing or garment accessory comprising at least a piece of fabric with a pair of sleeves configured to be worn by a user, integrating a wearable computing platform, power wires, communication wires, and/or connection points at several places including an inner surface, an outer surface, and/or in between the inner and outer surface of the clothing or garment, in accordance with an embodiment of the present invention. Power wires, communication wires, and/or connection points may be incorporated as conductive threads. A wearable computing platform 100 may comprise of at least a central processing unit 105, a display unit 110, an optional radio unit 115, one or more optional functional units 120, one or more battery units 125, one or more solar panel units 130, one or more power lines 135, an ear speaker unit 140, and/or a microphone unit 145, sewn or attached into the fabric of the clothing or garment accessory. Wearable computing platform 100 may be integrated into a clothing or wearable garment accessory such as, but not limited to, a shirt, a blouse, a T-shirt, a sweatshirt, a hoodie, a jacket, a coat, pants, a skirt.

FIG. 1B illustrates a back view of an exemplary wearable computing platform, in accordance with an embodiment of the present invention. FIG. 1B depicts the following elements from FIG. 1A: a display unit 110, a radio unit 115, one or more solar panels 130, one or more power lines 135, and a radio antenna 150. The back of wearable computing platform 100 comprises of one or more additional functional units 155, an internal weather control unit 160, one or more additional batteries 165, and a battery control unit 170.

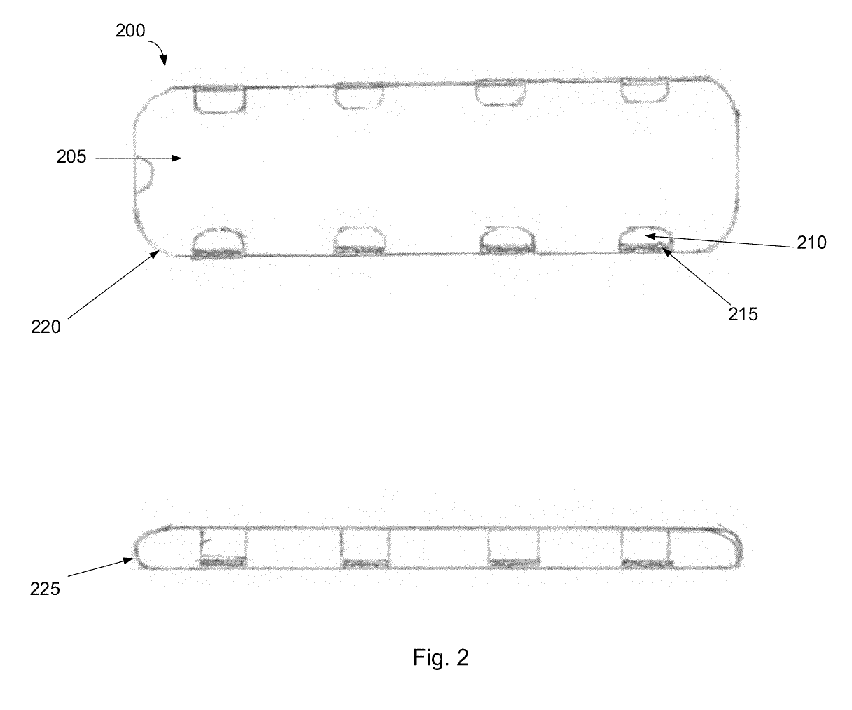

FIG. 2 illustrates a design of an exemplary soft chip, in accordance with an embodiment of the present invention. The soft chip 205 is an integrated circuit or any type of electronic circuit that is encapsulated in soft material such as rubber instead of hard material such as epoxy, silicone or polyimide, and formed into relatively flat and smooth shape with no sharp edges or corners. It has holes 210 and metal contact bars 215 in place of pins. A top view of a soft chip 220 and a side view of a soft chip 225 depict a plurality of holes 210 with metal contact bars 215 over each hole 210. A conductive thread may be woven through a hole 210 and around a metal contact bar 215 to electrically couple a soft chip 205 to other electronic part.

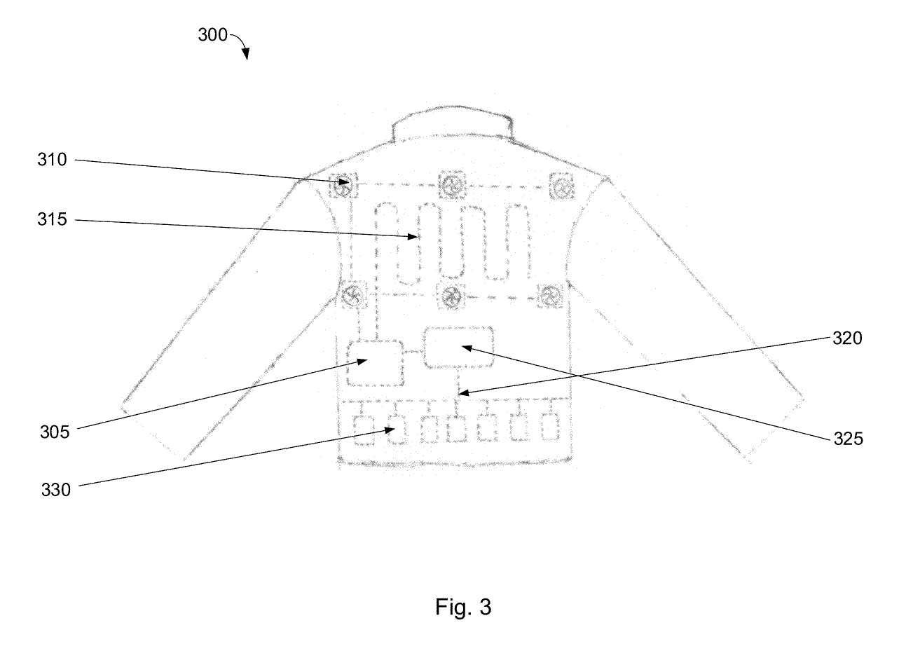

FIG. 3 illustrates an exemplary thermal regulation configuration of a wearable computing platform, in accordance with an embodiment of the present invention. A thermal regulation module 300 comprises of an internal weather control unit 305, one or more fans 310, one or more heating coils 315, one or more power lines 320, a battery control unit 325, and one or more batteries 330. Internal weather control unit 305 is connected to one or more fans 310, one or more heating coils 315, a battery control unit 325, and one or more batteries 330 (165 in FIG. 1B for more details) via one or more power lines 320 (135 in FIG. 1B for more details). A battery control unit 325 (170 in FIG. 1B for more details) controls and regulates power output of one or more batteries 330 and power the internal weather control unit 305, one or more fans 310, and one or more heating coils 315. During typical operation, internal weather control unit 305 may regulate one or more fans 310 and/or one or more heating coils 315 to control the temperature and/or humidity of a wearable computing platform.

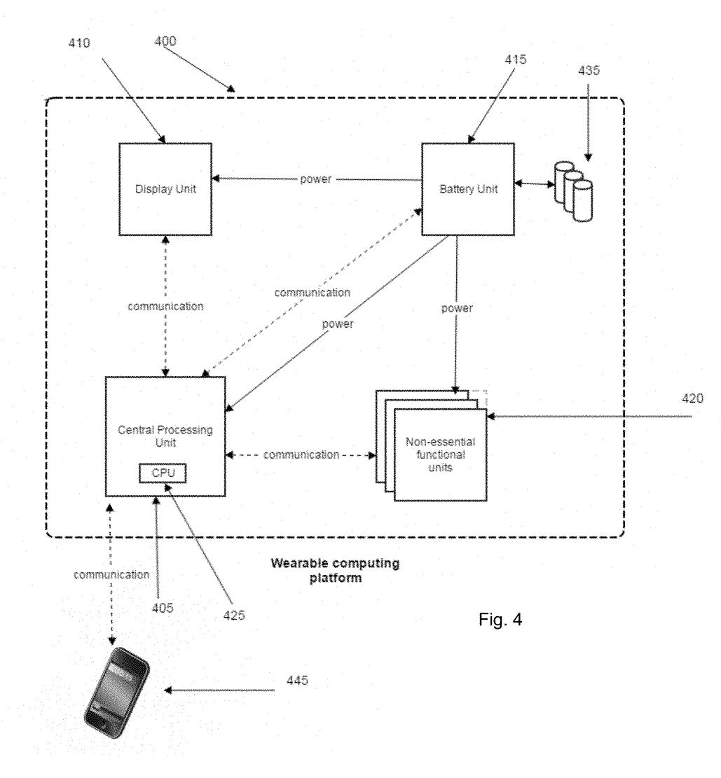

FIG. 4 illustrates the architecture of an exemplary wearable computing platform, in accordance with an embodiment of the present invention. Wearable computing platform architecture 400 comprises of a central processing unit 405, a display unit 410, a battery unit 415, and non-essential units 420. A central processing unit 405 has means to process information and commands received from other units, sensors, and/or a user. Central processing unit 405 is linked with all of the other units wired or wirelessly. A display unit 410 has a means to display information to a user and/or receive user input. In the display unit 410 a display screen can be used to display graphical interfaces to a user and a touch screen overlaid on top of the display screen can be used to receive user touch inputs. A battery unit 415 is coupled to one or more elements of computing platform architecture 400 and provides any necessary electric power from one or more batteries 435 to power the one or more elements. Non-essential units 420 may be modularly added and provide additional functions and/or data gathering sensors to wearable computing platform architecture 400. Central processing unit 405 has microphones (see 145 in FIG. 1A for more details) and speakers (see 140 in FIG. 1A for more details).

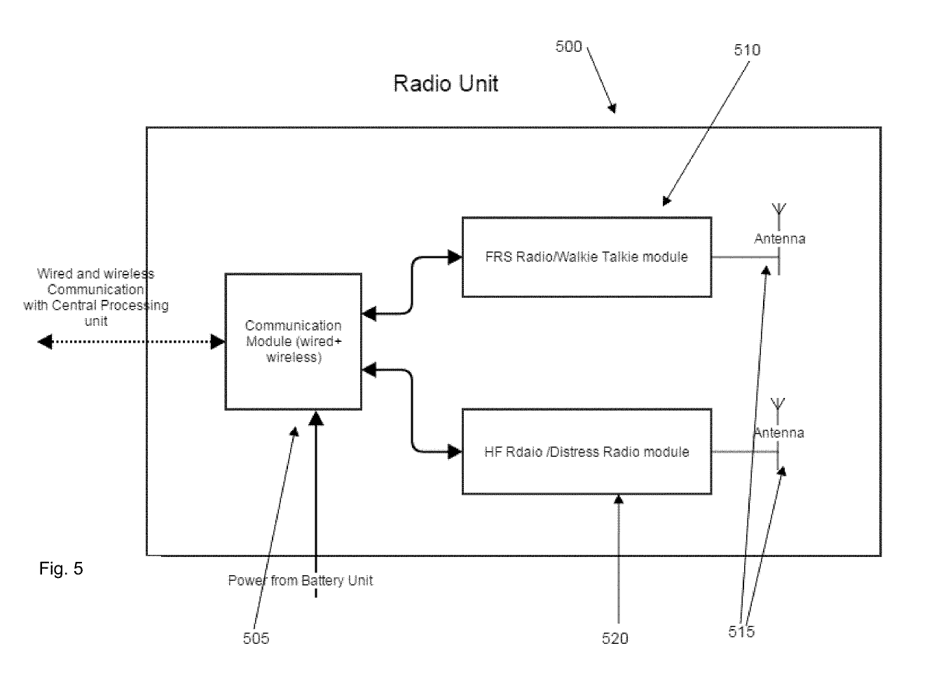

FIG. 5 illustrates an exemplary radio unit, in accordance with an embodiment of the present invention. A radio unit 500 comprises of a communication module 505, a FRS radio module 510, a HF radio module 520, antennas 515, a power management module 525 and battery 530, which is optional since there is battery unit 415 in the wearable computing platform providing power to every unit. FRS radio module 510 provides walkie talkie function in outdoor environment. HF radio module 520 provides distress radio call function for wilderness survival scenario. Antennas 515 can be conductive threads sewn on the sleeves of the jacket shown as 150 in FIG. 1A and FIG. 1B. Signals sent to and received from radio modules 510 and 520 are received from and sent to an applet running on central processing unit 405 through a communication module 505. User talks to mic 145 and listens to speaker 140 that are connected to central processing unit 405. The GUI of the applet is displayed on display unit 410.

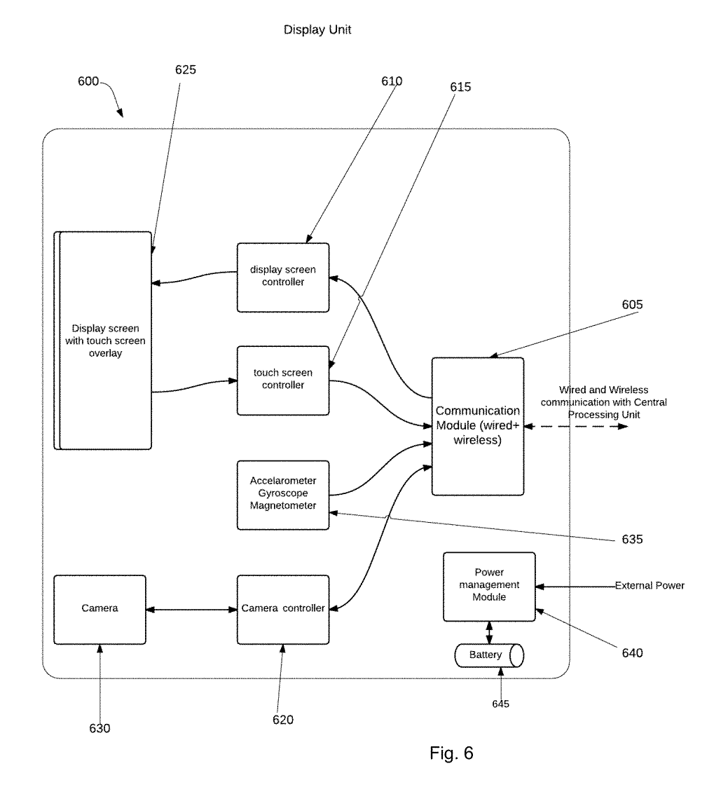

FIG. 6 illustrates the architecture of an exemplary display unit 410, in accordance with an embodiment of the present invention. A display unit 600 comprises of a communication module 605, a display screen controller 610, a touch screen controller 615, a camera controller 620, one or more cameras 630, one or more display screen with touch screen overlay 625, a module of accelerometer, gyroscope and magnetometer 635, and a power management unit 640, which manages the power of internal battery 645 and external power. Display screen controller 610 receives display information from communication module 605 which receives the display information from central processing unit 405, and displays the information onto display screen 625. User input may be captured from the touch screen overlay on display screen 625 and sent to communication module 605 for transmission to a central processing unit 405. A camera controller 620 controls one or more camera 630. Module of accelerometer, gyroscope and magnetometer 635 generates data that is used to determine the orientation of displayed graphic on display screen 625. Module 635 can also work with camera controller 620 to gather user information such as, but not limited to, eye tracking, gaze detection. Information from elements of display unit 600 may be sent through communication module 605 to central processing unit 405, which has an application processor to process the information and send the processed information or commands to other units or linked electronic device in the system. Communication module 605 provides the connections to central processing unit 405 in wired or wireless means such as, but not limited to, direct connection metal or optical fiber cable, Ethernet cable, Wi-Fi, Bluetooth, and NFC.

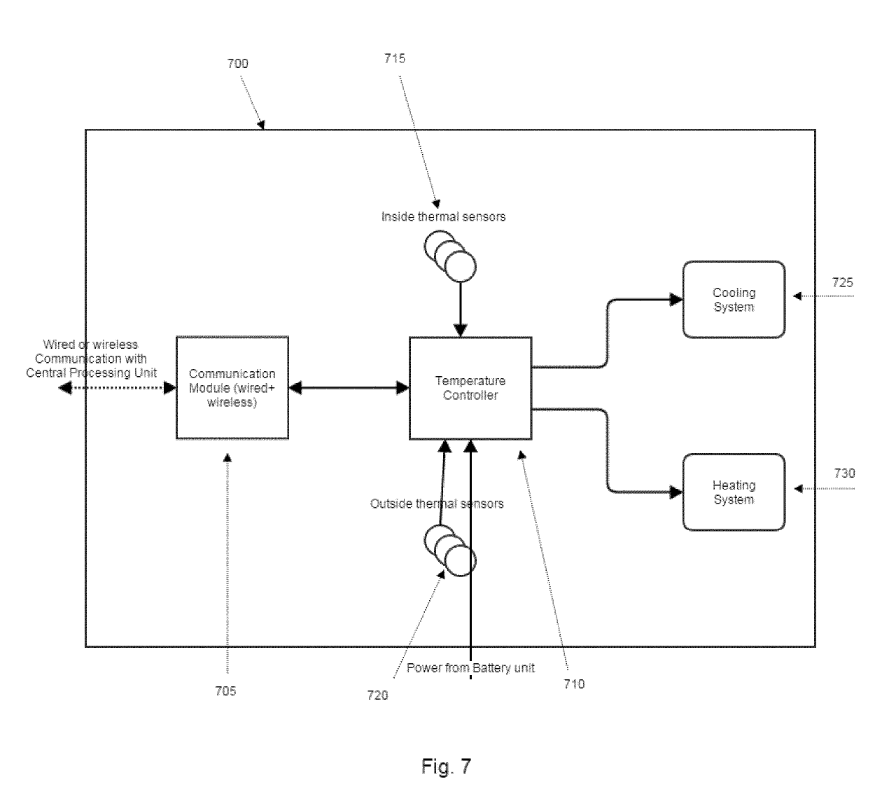

FIG. 7 illustrates an exemplary thermal regulation unit, in accordance with an embodiment of the present invention. A thermal regulation unit 700 comprises of a communication module 705, a temperature controller 710, one or more inside temperature sensors 715, one or more outside temperature sensors 720, a cooling system 725, and a heating system 730. Temperature controller 710 receives temperature information about the inside and outside of a garment integrated with a wearable computing platform from inside temperature sensor 715 and outside temperature sensor 720 respectively. Based on temperature information and a user's desired temperature and/or humidity, temperature controller 710 may activate a cooling system 725 and/or a heating system 730 to achieve a specific temperature and/or humidity. Temperature controller 710 sends sensor data to a communication module 705 which in turn send the information to a central processing unit 410 through wired or wireless connection for processing. Central processing unit 410 issues command based on the information back to temperature controller 710 to starts either the cooling system 725 or the heating system 730 or do nothing.

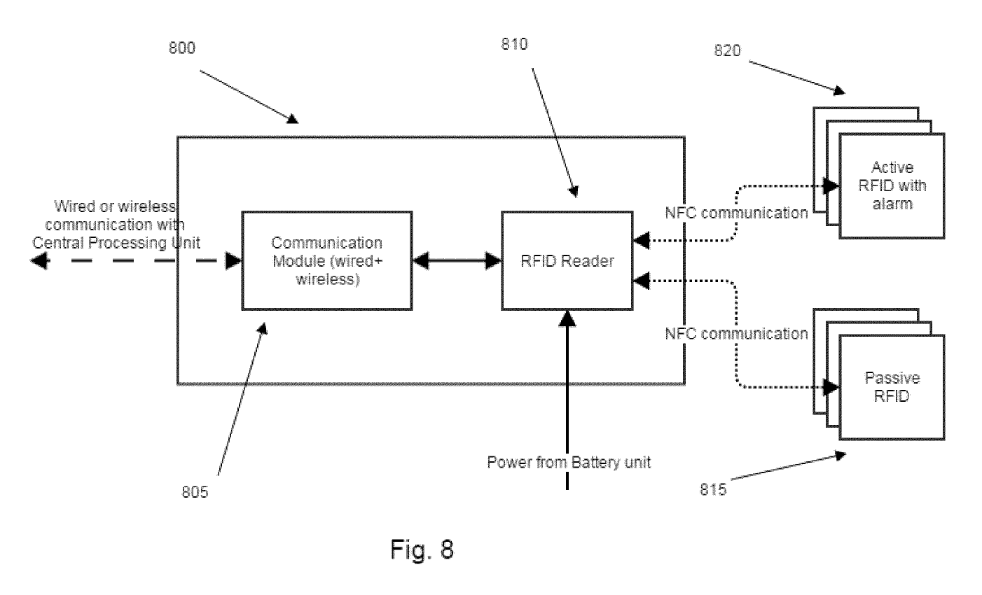

FIG. 8 illustrates an exemplary RFID unit, in accordance with an embodiment of the present invention. A RFID unit 800 comprises of a communication module 805, a RFID reader 810, and one or more passive RFID with alarms 815. and/or one or more active RFID tags 820.

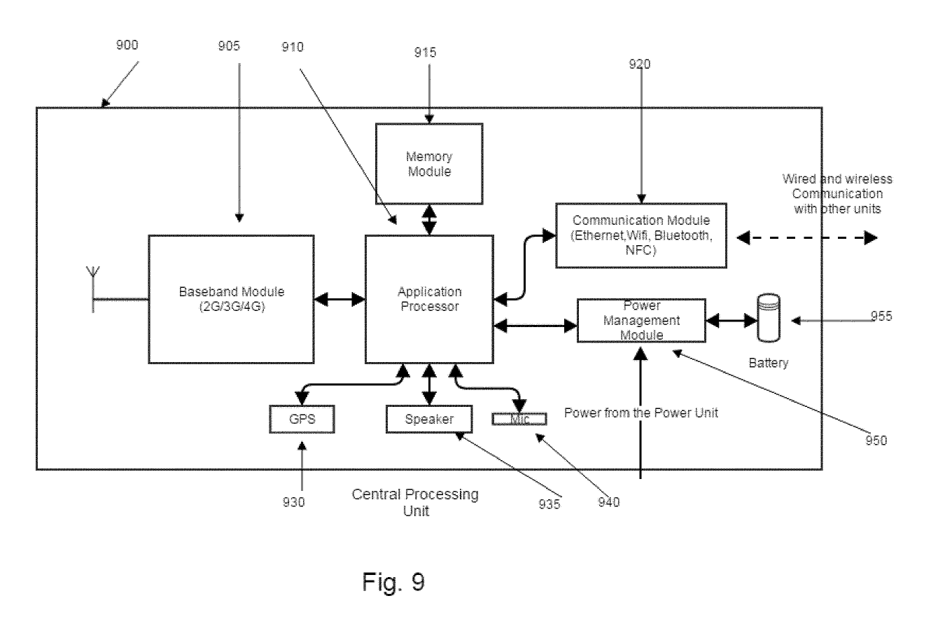

FIG. 9 illustrates the architecture of an exemplary central processing unit 405, in accordance with an embodiment of the present invention. A central processing unit 900 comprises of an application processor 910, on which the operating system, software application and applets run, a baseband module 905 which provides the cellular wireless phone and data communication, a memory module 915, a communication module 920 which connects to other units or devices in wired or wireless means such as, but not limited to, direct connection metal or optical fiber cable, Ethernet cable, Wi-Fi, Bluetooth, and NFC, and controls the communication with all other units in the platform, a power management module 950 which manages power from internal battery 955 and power from the Power Unit 415, a GPS 930, speakers 935, microphones 940.

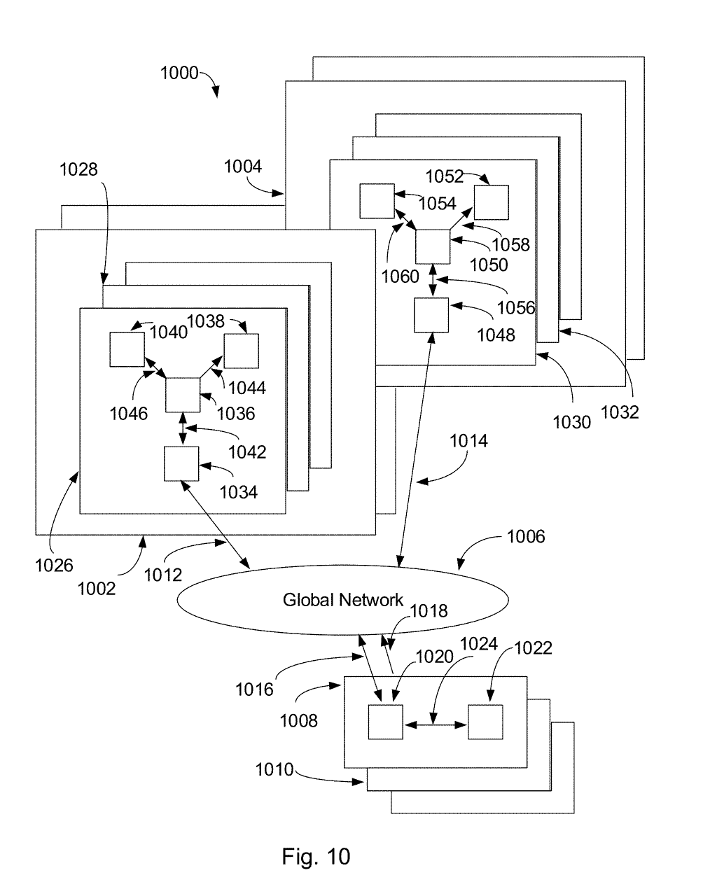

FIG. 10 illustrates a block diagram depicting a conventional client/server communication system.

A communication system 1000 includes a multiplicity of networked regions with a sampling of regions denoted as a network region 1002 and a network region 1004, a global network 1006 and a multiplicity of servers with a sampling of servers denoted as a server device 1008 and a server device 1010.

Network region 1002 and network region 1004 may operate to represent a network contained within a geographical area or region. Non-limiting examples of representations for the geographical areas for the networked regions may include postal zip codes, telephone area codes, states, counties, cities and countries. Elements within network region 1002 and 1004 may operate to communicate with external elements within other networked regions or within elements contained within the same network region.

In some implementations, global network 1006 may operate as the Internet. It will be understood by those skilled in the art that communication system 1000 may take many different forms. Non-limiting examples of forms for communication system 1000 include local area networks (LANs), wide area networks (WANs), wired telephone networks, cellular telephone networks or any other network supporting data communication between respective entities via hardwired or wireless communication networks. Global network 1006 may operate to transfer information between the various networked elements.

Server device 1008 and server device 1010 may operate to execute software instructions, store information, support database operations and communicate with other networked elements. Non-limiting examples of software and scripting languages which may be executed on server device 1008 and server device 1010 include C, C++, C# and Java.

Network region 1002 may operate to communicate bi-directionally with global network 1006 via a communication channel 1012. Network region 1004 may operate to communicate bi-directionally with global network 1006 via a communication channel 1014. Server device 1008 may operate to communicate bi-directionally with global network 1006 via a communication channel 1016. Server device 1010 may operate to communicate bi-directionally with global network 1006 via a communication channel 1018. Network region 1002 and 1004, global network 1006 and server devices 1008 and 1010 may operate to communicate with each other and with every other networked device located within communication system 1000.

Server device 1008 includes a networking device 1020 and a server 1022. Networking device 1020 may operate to communicate bi-directionally with global network 1006 via communication channel 1016 and with server 1022 via a communication channel 1024. Server 1022 may operate to execute software instructions and store information.

Network region 1002 includes a multiplicity of clients with a sampling denoted as a client 1026 and a client 1028. Client 1026 includes a networking device 1034, a processor 1036, a GUI 1038 and an interface device 1040. Non-limiting examples of devices for GUI 1038 include monitors, televisions, cellular telephones, smartphones and PDAs (Personal Digital Assistants). Non-limiting examples of interface device 1040 include pointing device, mouse, trackball, scanner and printer. Networking device 1034 may communicate bi-directionally with global network 1006 via communication channel 1012 and with processor 1036 via a communication channel 1042. GUI 1038 may receive information from processor 1036 via a communication channel 1044 for presentation to a user for viewing. Interface device 1040 may operate to send control information to processor 1036 and to receive information from processor 1036 via a communication channel 1046. Network region 1004 includes a multiplicity of clients with a sampling denoted as a client 1030 and a client 1032. Client 1030 includes a networking device 1048, a processor 1050, a GUI 1052 and an interface device 1054. Non-limiting examples of devices for GUI 1038 include monitors, televisions, cellular telephones, smartphones and PDAs (Personal Digital Assistants). Non-limiting examples of interface device 1040 include pointing devices, mousse, trackballs, scanners and printers. Networking device 1048 may communicate bi-directionally with global network 1006 via communication channel 1014 and with processor 1050 via a communication channel 1056. GUI 1052 may receive information from processor 1050 via a communication channel 1058 for presentation to a user for viewing. Interface device 1054 may operate to send control information to processor 1050 and to receive information from processor 1050 via a communication channel 1060.

For example, consider the case where a user interfacing with client 1026 may want to execute a networked application. A user may enter the IP (Internet Protocol) address for the networked application using interface device 1040. The IP address information may be communicated to processor 1036 via communication channel 1046. Processor 1036 may then communicate the IP address information to networking device 1034 via communication channel 1042. Networking device 1034 may then communicate the IP address information to global network 1006 via communication channel 1012. Global network 1006 may then communicate the IP address information to networking device 1020 of server device 1008 via communication channel 1016. Networking device 1020 may then communicate the IP address information to server 1022 via communication channel 1024. Server 1022 may receive the IP address information and after processing the IP address information may communicate return information to networking device 1020 via communication channel 1024. Networking device 1020 may communicate the return information to global network 1006 via communication channel 1016. Global network 1006 may communicate the return information to networking device 1034 via communication channel 1012. Networking device 1034 may communicate the return information to processor 1036 via communication channel 1042. Processor 10106 may communicate the return information to GUI 10108 via communication channel 1044. User may then view the return information on GUI 1038.

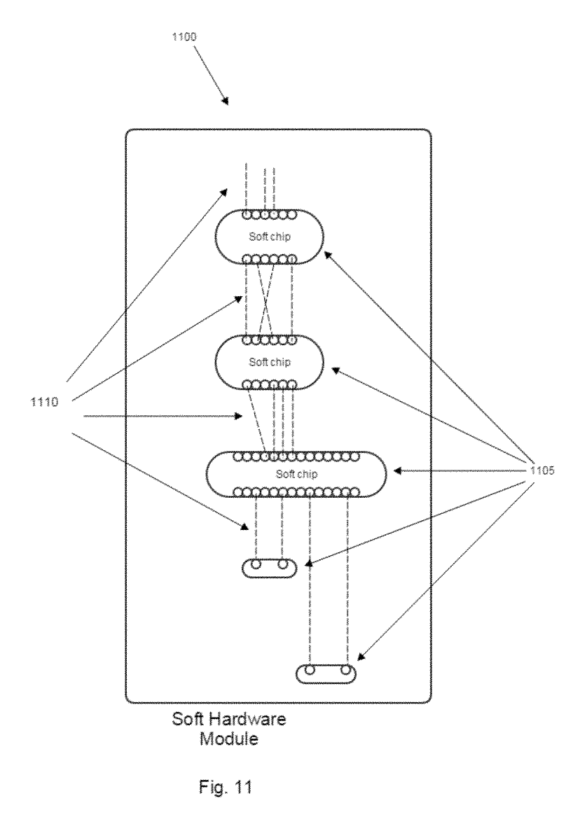

FIG. 11 illustrates an exemplary configuration of a soft hardware module. A soft hardware module 1100 may comprise of a plurality of soft chips 1105 (see 205 in FIG. 2 for more details), which may be laid out flat on a fabric or other soft material instead of a typically used circuit board. Soft chip 1105 may be sewn onto the fabric or soft material and interconnected with each other with conductive threads 1105, creating an attachable soft hardware module 1100. Attachable hardware module may be attached to an inner or an outer surface of a garment that is integrated with wearable computing platform 100 via conductive threads.

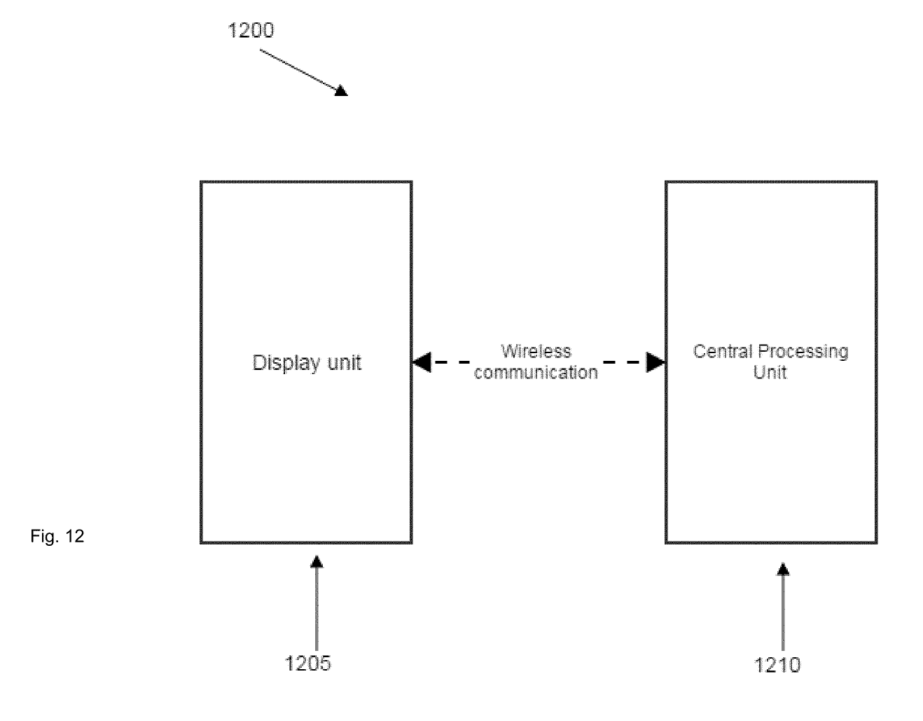

In an alternative embodiment of the present invention, which is illustrated in FIG. 12, wearable computing platform architecture 1200 comprises of only display unit 1205 and central processing unit 1210. A central processing unit 1210 communicates with display unit 1205 in wired or wireless means such as, but not limited to, direct connection metal cables, direct connection optical fiber cable, Ethernet cable, Wi-Fi, Bluetooth, and NFC. A central processing unit 1210 has a means to process information and commands received from display unit 1205 and send display graphic data to display unit 1205. In the display unit 1205, a display screen is used to display graphical interfaces to a user and a touch screen overlay on top of the display screen is used to receive user touch inputs. Both central processing unit 1210 and display unit 1205 have internal batteries. Central processing unit 1210 has more batteries with bigger capacities than the batteries in display unit 1205. So, the internal battery of display unit 1205 can be recharged by the batteries in central processing unit 1210 when the two units are connected by wire or through direct contact. The recharging can happen wired or wirelessly. The display screen in display unit 1205 can be flexible or bendable display. The battery in display unit 1205 can also be flexible or bendable. So, the entire display unit 1205 can be flexible or bendable.

Hardware and/or function units may be modularly integrated with the wearable computing platform 100 as soft hardware modules 1100, wherein all the integrated circuits are packaged in soft chips 200, which are flat, smooth shaped and soft material packaged chips, and attached or sewn to a soft fabric or flexible material, instead of printed circuit boards. A soft hardware module may be sewn or attached to the inner surface, outer surfaces, and/or in between the inner and outer surface of the clothing or garment accessory. In soft chip, integrated circuit pins or connections may be replaced with metal loops and/or rings or holes with metal edges for conductive threads to tie into and allow for the soft chip to be sewn into a clothing or garment configured to form an open hardware platform within the clothing or garment accessory.

Central processing unit 105 may control all the hardware and functional units on the wearable computing platform 100 in a wired or wireless means such as, but not limited to, direct connection metal cables, direct connection optical fiber cable, Ethernet cable, Wi-Fi, Bluetooth, and NFC. Central processing unit 105 may execute computer code and/or algorithms, such as operating system, software or applets, from a non-transitory computer readable medium. Central processing unit has baseband module (cellular wireless module) enabling it to join the wireless phone network. Central processing unit also has communication modules enabling it to communicate with other units in wired or wireless means or topology such as, but not limited to, direct connection metal cables, direct connection optical fiber cable, Ethernet cable, Wi-Fi, Bluetooth, and NFC. A display unit 110 has a display screen which displays data and/or graphical user interfaces of operating system, software or applets running on central processing unit. The display unit also has a touch screen overlay on top of the display screen that senses the touch of user. The display unit may be lightweight and self-powered to enable usage when not physically connected to wearable computing platform 100. The display unit may be flexible or bendable when equipped with flexible and bendable display screen and battery. The display unit has a communication module enabling it to communicate with central processing unit 105 in wired or wireless means such as, but not limited to, direct connection metal cables, direct connection optical fiber cable, Ethernet cable, Wi-Fi, Bluetooth, and NFC. A radio unit 115 is an optional non-essential functional unit. It comprises of an antenna 150 and FRS radio walkie talkie module and HF distress radio module which can be used for outdoor survival communication. The radio unit also has communication module enabling it to communicate with central processing unit 105 in wired or wireless means such as, but not limited to, direct connection metal cables, direct connection optical fiber cable, Ethernet cable, Wi-Fi, Bluetooth, and NFC. One or more optional functional units 120 may be modularly added to wearable computing platform 100 and may add functional hardware such as, but not limited to, a weather control unit for thermal regulation, an RFID tracking, monitoring, tagging and/or reading unit for tracking or monitoring objects equipped with RFID, a non-transitory computer readable mediums for storing data, executable programs, and/or software apps or applications, a GPS unit for tracking, monitoring, and/or navigation, a vital sign sensing unit for detecting a user's vital signs, a therapeutical medical device unit such as, but not limited ventilators, hemodialysers, pacemakers, infusion pumps, and deep-brain or spinal stimulators being configured to augment or, in some cases, replace certain critical physiological functionalities, or provide needed pain therapy, etc.

One or more batteries 125 may power wearable computing platform 100. Batteries 125 may be any number and/or type such as, but not limited to, a heterogeneous bank of batteries, a single lithium-ion battery, lithium-polymer batteries. Batteries 125 may be charged by power source outside the system, or by one or more solar panels 130. One or more hardware components, functional units, and/or electronic devices may be powered by the one or more batteries 125 and/or the one or more solar panels 130. Power lines 135 may connect one or more hardware components, functional units, and/or electronic devices with the batteries 125 and/or the solar panels 130. Additionally, power lines 135 may carry data from the one or more hardware components, functional units, and/or electronic devices. Power lines 135 may be installed by being woven into the material of the garment that wearable computing platform 100 is integrated with and/or applied on the surface of the garment.

Peripherals such as earspeaker 140 and microphone 145 may be modularly integrated with wearable computing platform 100 to interface with a user. Earspeaker 140 may relay audio information to a user and microphone 145 may receive and send audio information from a user to one or more elements of wearable computing platform 100.

In a embodiment of the present invention, user can pick up a phone call by touching the touch screen display in display unit 110, speaks hands-free to microphone 145, the voice signal is transmitted to baseband module (cellular phone module) in central unit 105, and then transmitted into the cellular wireless network. Baseband module receives voice signal from the cellular wireless network and transmits the signal to the earspeaker 140.

In another embodiment of the present invention, an electronic device such as a smartphone is integrated into the wearable computing platform 100 as an applet running on central processing unit 105 communicates with the smartphone through the communication module in central processing unit 105 in wired or wireless means such as, but not limited to, direct connection metal cables, direct connection optical fiber cable, Ethernet cable, Wi-Fi, Bluetooth, and NFC, A user may operate the smart phone by touching the touchscreen in display unit 110, or hands-free via voice commands spoken into microphone 145 and hearing audible notifications and/or responses from earspeaker 140.

During typical operation, wearable computing platform 100 may be worn by a user. Central processing unit 105 processes data from any functional units 120 and/or sensors. Commands may be given by central processing unit 105 to any functional units 120 according to computer code such as, but not limited to, software and applets, located within a non-transitory computer readable medium. A user may link an electronic device such as, but not limited to, a smartphone, a tablet, a device, home appliance, medical devices to wearable computing platform 100 and control the electronic device in a hands free manner via display unit 110, peripherals such as earspeaker 140 and microphone 145, and/or any functional units 120. Additional functional units 120 may be modularly added to wearable computing platform 100 based on a user's needs or requirements.

A user may additionally detach display unit 110 to remotely operate an electronic device linked with wearable computing platform 100. A user may also control any modules connected with wearable computing platform 100 via inputs entered into display unit 110. User inputs may be, but not limited to, touch inputs, gestures, voice commands, hardware button. Display unit 110 may comprise of flexible or bendable display screen and flexible or bendable battery, so that display unit 110 is flexible and bendable.

It may be appreciated by a person with ordinary skill in the art that wearable computing platform 100 may be integrated with nearly any flexible material. Wearable computing platform 100 may be integrated with materials such as, but not limited to, leather, thin plastic, natural fibers, synthetic fibers, rubber, latex, wool. In another embodiment of the present invention, wearable computing platform 100 may be integrated with a wool blanket. In an alternative embodiment of the present invention, wearable computing platform 100 may be integrated with a food or beverage container The wearable computing platform can also integrate and control electronic systems in the surrounding, for example, home appliances, electronic devices.

It may be appreciated by a person with ordinary skill in the art that there may be a plurality or none of an element in wearable computing platform 100. In another embodiment of the present invention, wearable computing platform 100 may contain no batteries and may be powered completely by electric generating sources such as solar panels. In still another embodiment of the present invention, wearable computing platform 100 may contain a plurality of central processing units 105 which may be operating in parallel to increase the processing throughput of wearable computing platform 100.

In another embodiment of the present invention, there is simply a display unit and a central processing unit, where the central processing unit has data and logic processing function, cellular wireless phone and data function, communication functions such as direct connection metal or optical fiber cable, Ethernet, Wi-Fi, Bluetooth, NFC and batteries. The display unit has one or more display screens, one or more touch screen overlays, communication module and its own battery. The central processing unit sends its display data to display unit and receives user input from the touchscreen of the display unit through communication module in wired or wireless means such as, but not limited to, direct connection metal or optical fiber cable, Ethernet cable, Wi-Fi, Bluetooth, and NFC.

In another embodiment of the present invention, Central processing unit 105 doesn't have cellular wireless module. A physically separated cellular wireless unit is in the system to provide the cellular wireless phone and data service. This cellular wireless unit communicates with central processing unit in wired or wireless means such as, but not limited to, direct connection metal or optical fiber cable, Ethernet cable, Wi-Fi, Bluetooth, and NFC.

It may be appreciated by a person with ordinary skill in the art that there are various ways to modularly add elements to wearable computing platform 100. Elements may be added to wearable computing platform 100 by means such as, but not limited to, magnets, adhesives, melding, sewing, Velcro.

It may be appreciated by a person with ordinary skill in the art that a display from display unit 110 may be placed anywhere on a garment that wearable computing platform 100 is integrated to. In another embodiment of the present invention, one or more displays are attached to the inner sleeves of a jacket to allow a user to easily view and interact with any graphical user interfaces displayed.

It may be appreciated by a person with ordinary skill in the art that a display from display unit 110 may be nearly any kind of display. Displays from display unit 110 may be chosen for a specific application such as a flexible or bendable OLED display to retain a garment's softness.

It may be appreciated by a person with ordinary skill in the art that solar panels 130 may be nearly any power recharging technology. Solar panels 130 may be replaced or augmented with power recharging technology such as, but not limited to, thermoelectric generators, piezoelectric generators. In an alternative embodiment of the present invention, piezoelectric strips may be integrated with wearable computing platform 100 to harvest energy while a user moves while wearing wearable computing platform 100.

It may be appreciated by a person with ordinary skill in the art that one or more power lines 135 may be any medium. Power lines 135 may be mediums such as, but not limited to, wireless transmissions, heterogeneous wires, conductive threads. In another embodiment of the present invention, one or more power lines 135 may be transmitting power and/or data wirelessly via electromagnetic induction.

It may be appreciated by a person with ordinary skill in the art that antenna 150 may be any type of antenna. Antenna 150 may be types such as, but not limited to, a telescoping antenna, a wire antenna, a surface antenna, planar antenna. In another embodiment of the present invention, antenna 150 is one or more conductive threads woven into wearable computing platform 100.

It may be appreciated by a person with ordinary skill in the art that nearly any peripherals may be modularly added to wearable computing platform 100. Peripherals may be hardware such as, but not limited to, additional displays, Bluetooth headsets, video display glasses, touch pad, keyboard for input. In another embodiment of the present invention, a camera may be added to wearable computing platform 100 to capture user gestures and commands.

Wearable computing platform 100 may accommodate one or more additional functional units 155 on the back side. The additional functional units 155 may be located anywhere on wearable computing platform 100. An internal weather control unit 160 may be one of the additional functional units 155 and may be spread throughout the surface area of wearable computing platform 100. One or more additional batteries 165 may be located on the back of wearable computing platform 100. A battery control unit 170 may be located on the back of wearable computing platform 100 and controls the usage and charging of independent batteries 125 and 165.

During typical operation, the battery control unit 170 may power the wearable computing platform 100 by drawing the electricity from batteries 125 and 165, and can charge the batteries 125 and 165 by solar panels 130. Internal weather control unit 160 may control the temperature of wearable computing platform 100 to suit a user's preferences or to optimize the performance of wearable computing platform 100.

It may be appreciated by a person with ordinary skill in the art that any element of wearable computing platform 100 may be located at any location on a garment which wearable computing platform 100 is integrated on. Elements of wearable computing platform 100 may occupy the same space, occupy different sides of a location, and/or overlap. In another embodiment of the present invention, internal weather control unit 160 may cover the entirety of the inner side of the garment which wearable computing platform 100 is integrated on and other elements of wearable computing platform 100 may be located on the outer side of the garment.

It may be appreciated by a person with ordinary skill in the art that an attachable soft hardware module 1100 may be designed in any shape, size, and/or pin configuration. In another embodiment of the present invention, attachable soft hardware module 1100 may be a circular shape in order to patch an area of a garment. In still another embodiment of the present invention, any circuitry of attachable soft hardware module 1100 may be printed on soft material instead of implementing conductive thread 1110 to couple soft chips 1105 together. In an ideal case, any modules in any units of this wearable computing platform 100 are soft hardware modules.

It may be appreciated by a person with ordinary skill in the art that a soft chip 200 may have substitute contact designs for holes 210 and metal contact bars 215. Substitute contact designs may include, but not limited to, surface welding points, sockets, metal rings. In an alternative embodiment of the present invention, soft chip 200 may have through holes with metal contact walls to allow for a conductive thread to woven through soft chip 200.

It may be appreciated by a person with ordinary skill in the art that a soft hardware module 1100 may operate independently from a wearable computing platform 100. In another embodiment of the present invention, one or more soft hardware modules 1100 may be attached to bedding products such as pillows to gather data and transmit the data to a user or user device.

It may be appreciated by a person with ordinary skill in the art that there are many ways to cool a wearable computing platform 100 other than by cooling fans. Applicable cooling technology such as, but not limited to, Freon, Peltier coolers, may be implemented with or instead of one or more fans 310. In another embodiment of the present invention, a wearable computing platform 100 is cooled by Freon being circulated within and/or around the garment integrated with wearable computing platform 100.

It may be appreciated by a person with ordinary skill in the art that there are many ways to heat a wearable computing platform 100 other than by heating coils. Applicable heating technology such as, but not limited to, friction heaters, infrared lights, may be implemented with or instead of one or more heating coils 315. In another embodiment of the present invention, a wearable computing platform 100 is heated by hot air circulated within and/or around the garment integrated with wearable computing platform 100.

It may be appreciated by a person with ordinary skill in the art that there can be many variations of the present invention. In an alternative embodiment of central processing unit 900 in the present invention, baseband module 905 can be removed from the unit and become a baseband unit, or merge with other unit such as radio unit. In yet another embodiment of central processing unit 900, new functional modules can be included, such as, user input module that drives keyboard or touchpad.

In an alternative embodiment of the present invention, display unit 410 (See 600 in FIG. 6 for more details) is soft unit which comprises of all soft hardware modules including one or more display screen 625 that are flexible or bendable display 625, flexible or bendable battery 645, soft display controller 610, soft touch screen controller 615, soft module of accelerometer, gyroscope and magnetometer 635, soft module of communication 605, so the display unit 600 is flexible and bendable therefore more wearable.

In an embodiment of present invention, the central processing unit 405 (See 900 in FIG. 9 for more details) is a soft unit in which all modules are soft hardware modules, the batteries are flexible or bendable, the coupling of modules or elements uses soft conductive material and modules or elements are attached onto soft materials.

In an embodiment of present invention, all the batteries in the battery unit 415 are soft flexible and bendable, and the controlling modules in battery units are soft hardware modules.

In general, all functional units 420 in the wearable computing platform can be soft unit. They comprise of soft hardware modules that coupled together with soft conductive materials and are fixed onto or cased in soft material.

A typical and simple implementation of wearable computing platform 400 is like the following: Baseband module 905 of central processing unit 405 (See 900 in FIG. 9 for more details) provides functions of cellular wireless phone and data communication. Operating system, application software including the ones controlling wireless phone and data function and applets run on application processor 910 of central processing unit 405 (See 900 in FIG. 9 for more details). GUI interface of the operating system, application software and applets is displayed onto one or more display screen 625 in display unit 410 (See 600 in FIG. 6 for more details) via wired or wireless connection between display unit 410 and central processing unit 405. One or more display screens 625 can be any screen such as but not limit to, LCD, OLED, AMOLED hard screen, flexible/bendable screen, 3D screen or transparent screen. Display unit 410 (600) receives user input or command as users touch or swipes the touch screen overlay on accelerometer, gyroscope and magnetometer 635. User input or commands generated by user's touching of touch screen overly 625 plus signals or data from devices such as module of accelerometer, gyroscope and magnetometer 635 are sent to central processing unit 405 (See 900 in FIG. 9 for more details) for processing via wired or wireless communication. One or more cameras 630 in display unit 410 (See 600 in FIG. 6 for more details) also send the audio and video data stream back to central processing unit 405 (See 900 in FIG. 9 for more details). Battery unit 415 provides power to all other units via power cables. This power provides as alternative power and/or charging power to the batteries in individual unit such as 955 in 900 and 645 in 600.

Another implementation of wearable computing platform 400 may be link either wired or wirelessly to a user's electronic device 445. Central processing unit 405 (See 900 in FIG. 9 for more details) connects with electronic device 445 and/or other modules through the communication module 920. Display unit 410 (See 600 in FIG. 6 for more details) may display, on one or more display screen with touch screen overlay 625, a graphical interface from electronic device 445 or any processed information from central processing unit 405 (See 900 in FIG. 9 for more details). A user may interact with electronic device 445 and/or any non-essential unit 420, peripherals, interfaces attached to the wearable computing platform by touchscreen 625.

Another implementation of wearable computing platform 400 may comprise a plurality of soft display units 410 that can cover most of the human body. The display screens can change color, brightness, and graphics based on surrounding environment to make the person visually blend into the surrounding or transparent to viewers. This implementation can be used as camouflage.

Another implementation of wearable computing platform 400 may comprise of a plurality of soft display units 410 with large size of screens on the outer surface of a person's clothes. The screens can be used as safety signs, billboards, message board.

Yet another implementation of wearable computing platform 400 may comprise of small display unit 410 which is small enough to be put on the lens of eye glasses.

It may be appreciated by a person with ordinary skill in the art that the units in wearable computing platform architecture 400 may be found in one device or spread over multiple devices which may or may not be physically connected with wearable computing platform architecture 400. In another embodiment of the present invention, central processing unit 405, display unit 410, and battery unit 415 may be located in one device, such as a smartphone, and be integrated with the rest parts of a wearable computing platform.

It may be appreciated by a person with ordinary skill in the art that a processing unit 405 may include additional electronic hardware to assist with processing or communication with other modules. Additional electronic hardware may be, but not limited to, RAM, non-transitory computer readable mediums, cellular wireless modules, and/or wired and wireless communication modules. In another embodiment of the present invention, processing unit 405 may contain a plurality of wireless communication modules to communicate with modules using heterogeneous communication protocols.

It may be appreciated by a person with ordinary skill in the art that there may be one or none of battery unit 415 in wearable computing platform architecture 400. In another embodiment of the present invention, every unit in wearable computing platform architecture 400 may have a dedicated battery module.

It may be appreciated by a person with ordinary skill in the art that nearly any software may be performed by computer processor 425 in central processing unit 405. In another embodiment of the present invention, any operating system may be executed by computer processor 425 and applets running on an operating system may allow a user further configure, control, and/or monitor other units, modules and/or sensors.

During typical operation, a functional unit 420 or a battery unit 415, or an electronic device is linked with central processing unit 405 wired or wirelessly and is controlled by software application or applet running on a central processing unit 405 (See 900 in FIG. 9 for more details). Central processing unit 405 (See 900 in FIG. 9 for more details) sends display information to display unit 410 (See 600 in FIG. 6 for more details). A user may interact with touchscreen display 625 and any user input such as touching or swiping is sent to touch screen controller 615 and processed for further transmission to communication module 605. Data from a camera 630 and a module of accelerometer, gyroscope, magnetometer 635 may be gathered and sent to a central processing unit 405 (See 900 in FIG. 9 for more details) via communication module 605. The data gathered from a camera 630 and a module of accelerometer gyroscope, magnetometer 635 may be used to determine user commands and/or actions such as, but not limited to, gestures, movement. The central processing unit 405 (See 900 in FIG. 9 for more details) determines a desired command and/or desired action to be performed by a wearable computing platform and sends graphic data to the display screen controller 610 in display unit 600. Display screen controller 610 formats the graphic data for display on a touchscreen display 625 for a user to view.

It may be appreciated by a person with ordinary skill in the art that the capabilities and/or functions of touchscreen display 625 may be split among a plurality of electronic components. In another embodiment of the present invention, touchscreen display 625 may be replaced with such as but not limited to LCD, LED, OLED, AMOLED, flexible/bendable or 3D display and a physical input device, such as but not limited to a mechanical keyboard, optical keyboard, touchpad, gesture or movement sensor, voice receiver. In still another embodiment of the present invention, touchscreen display 625 may have a minimum capability of displaying graphical data and receiving a user input; any other capabilities may be performed by another electronic component such as other modules or linked electronic devices.

It may be appreciated by a person with ordinary skill in the art that a plurality of different elements in display unit 600 may be implemented. In another embodiment of the present invention, a plurality of cameras 630 may be implemented to acquire a wider image capture range. In still another embodiment of the present invention, a plurality of touchscreen displays 625 may be used to provide a larger viewing area for a user.

It may be appreciated by a person with ordinary skill in the art that one or more additional electrical components or modules may be integrated with display unit 600. Additional electrical components or modules may improve the functionality and/or performance of display unit 600. Electrical components or modules may be, but not limited to, power regulation circuitry, additional sensors, input devices. In another embodiment of the present invention, additional input devices such as a keyboard may be included in display unit 600 to allow a user to have more data and/or command input means. In another embodiment of the present invention, hardware drivers are integrated with controllers such as, but not limited to, display screen controller 610, touch screen controller 615, and camera controller 620.

It may be appreciated by a person with ordinary skill in the art that cooling system 725 may be any type of cooling system. Cooling system 725 may be, but not limited to, fans, Peltier coolers, Freon coolers. In another embodiment of the present invention, cooling system 725 may be mechanically controlled vents integrated with a garment.

It may be appreciated by a person with ordinary skill in the art that heating system 730 may be any type of heating system. Heating system 730 may be, but not limited to, heating coils, induction heating, microwaves, chemical reaction. In another embodiment of the present invention, heating system 730 may be infrared lights.

It may be appreciated by a person with ordinary skill in the art that a plurality of different elements in thermal regulation module 700 may be implemented. In another embodiment of the present invention, a plurality of heterogeneous cooling systems 725 and heating systems 730 may be controlled by temperature controller 710. In still another embodiment of the present invention, one or more or none of inside temperature sensor 715 and/or outside temperature sensor 725 may be implemented in thermal regulation module 700.

It may be appreciated by a person with ordinary skill in the art that one or more additional electrical components or modules may be integrated with thermal regulation module 700. Additional electrical components or modules may improve the functionality and/or performance of thermal regulation module 700. Electrical components or modules may be, but not limited to, power regulation circuitry, additional sensors.

In an alternative embodiment of present invention, thermal regulation module 700 is implemented in blanket or bed covers and/or mattress to regulate the temperature of the surrounding of human body during sleep.

During typical operation, RFID reader 810 may monitor passive RFID tags 815 or active FRID tag with alarm 820 that are attached onto objects to track the objects such as, but not limited to, clothes, bags, jewelry, wallets, small electronic devices. RFID reader 810 may alert a user whenever a tagged object leaves a user's immediate area. In another embodiment of the present invention, an alarm may be triggered whenever an active RFID tag 815 leaves a user's effective RFID range. Information from RFID reader 810 is sent to a communication module 805, which in turn send the information to central processing unit 410 (See 900 in FIG. 9 for more details) in wired or wireless means for further processing. The information can be fed to a monitoring applet running on 410 (See 900 in FIG. 9 for more details).

It may be appreciated by a person with ordinary skill in the art that RFID reader 810 may be a hardware module or a software module. In another embodiment of the present invention, RFID reader 810 is a software program running on a central processing unit 410 (See 900 in FIG. 9 for more details) that uses the NFC function of central processing unit 410 (See 900 in FIG. 9 for more details).

It may be appreciated by a person with ordinary skill in the art that one or more additional electrical components or modules may be integrated with RFID module 800. Additional electrical components or modules may improve the functionality and/or performance of RFID module 800. Electrical components or modules may be, but not limited to, power regulation circuitry, additional sensors or additional antennas.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation:

The prototype of a simple design of the wearable computing platform illustrated in FIG. 12 which including a display unit 1205 and central processing 1210 is likely to be done outside the jurisdiction of the USA. The actual implementation of the wearable computing platform on clothes illustrated in FIG. 1 is likely to be done outside the jurisdiction of the USA.

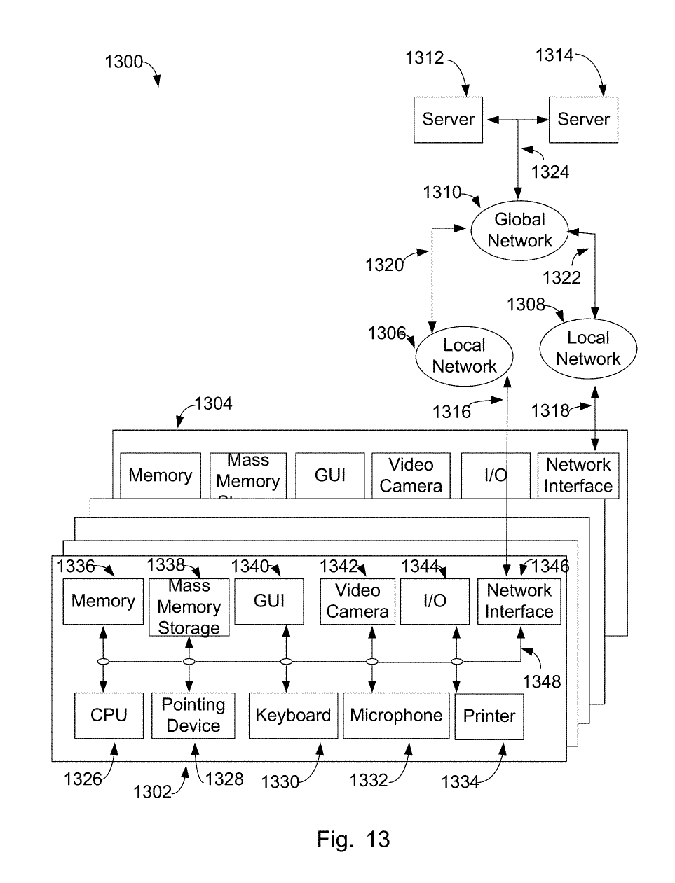

FIG. 13 is a block diagram depicting an exemplary client/server system which may be used by an exemplary web-enabled/networked embodiment of the present invention.

A communication system 1300 includes a multiplicity of clients with a sampling of clients denoted as a client 1302 and a client 1304, a multiplicity of local networks with a sampling of networks denoted as a local network 1306 and a local network 1308, a global network 1310 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breathe life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing wearable computing platforms according to the present invention will be apparent to those skilled in the art. Various aspects of the invention have been described above by way of illustration, and the specific embodiments disclosed are not intended to limit the invention to the particular forms disclosed. The particular implementation of the wearable computing platforms may vary depending upon the particular context or application. By way of example, and not limitation, the wearable computing platforms described in the foregoing were principally directed to clothing with embedded electronics implementations; however, similar techniques may instead be applied to body armor, aerospace test suits, medical devices, or video gaming, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a clothing or garment accessory, said clothing or garment accessory comprising at least a fabric with an inner surface and an outer surface being configured to be worn by a user; and
a wearable computing platform that is configured to be integrated with the fabric of the clothing or garment accessory, said wearable computing platform comprising:
a multiplicity of conductive threads incorporated in the fabric of the clothing or garment accessory, wherein the conductive threads being configured as power wires, communication wires and connection points;
a central processing unit comprising a non-transitory computer readable medium for storing an operating system and software app or applications, a controller being configured to execute the operating system and the software applications, and a communication module being configured to enable the central processing to communicate in a wired or wireless topology, in which the central processing unit is sewn onto a fabric with conductive threads, attached or sewn to the inner or outer surface of the clothing accessory, and covered with insulative layer;
a display unit connected to the central processing unit, the display unit comprising a display screen being configured to display the executed software applications, a touch screen overlay on top of the display screen for sensing a touch of a user, a power supply for providing power to the display unit after being detached from the clothing accessory, and a communication module being configured to wired or wirelessly communicate with the central processing unit;
a battery control unit, the battery control unit comprising a multiplicity of batteries, being configured to supply power to the central processing unit and the display unit through the power wires and other additional units; and
wherein a preconfigured software app running on the central processing unit provides a user interface displayed on the display screen of display unit being operable to control and communicate with at least one or many units of the wearable computing platform.

2. The system of claim 1, in which said wearable computing platform further comprising a solar panel unit connected to the battery control unit, the solar panel being configured to charge the batteries in battery control unit or provide a backup power supply.

3. The system of claim 1, in which said wearable computing platform further comprising a weather control unit connected to the central processing unit, the weather control unit comprises a controller being configured to adjust the temperature and humidity inside the clothing or garment accessory, the weather control unit further comprises a communication module being configured to wired or wirelessly communicate control signals with the central processing unit.

4. The system of claim 1, in which said wearable computing platform further comprising a radio unit connected to the central processing unit, the radio unit comprises at least an FRS module being configured for two-way radio communication, a HF radio module being operable for distress calls, and a communication module being configured to wired or wirelessly communicate with the central processing unit.

5. The system of claim 1, in which said wearable computing platform further comprising an object tracking device unit connected to the central processing unit, the object tracking device unit being configured to track or monitor at least one RFID unit attached to an object and trigger an alarm when the RFID unit becomes out of range of a predetermined distance.

6. The system of claim 1, in which said wearable computing platform further comprising a vital sign sensing unit connected to the central processing unit, the vital sign sensing unit being operable for detecting a system user's vital signs.

7. The system of claim 4, in which said radio unit further comprising antennas using conductive threads sewn on to the inner or outer surface of the clothing or garment accessory being configured to provide a wider coverage of the radio unit.

8. The system of claim 1, in which said wearable computing platform further comprising ear speakers being disposed on a proximate upper portion of the clothing or garment accessory collar, the ear speakers being configured to relay audio information.

9. The system of claim 1, in which said wearable computing platform further comprising microphones being disposed on a proximate mid-section portion of the clothing or garment accessory collar, the microphones being configured to receive and send audio information.

10. The system of claim 1, in which said clothing or garment accessory is at least one of a jacket, a coat, a shirt, a blouse, a T-shirt, a hoodie and a sweatshirt, and said wearable computing platform is an open computing platform.

11. The system of claim 1, in which said each unit may comprise a multiplicity of soft hardware modules which comprises a multiplicity of soft chips which are integrated circuits or electronic circuits that are encapsuled in soft material instead of hard material, and formed into relatively flat and smooth shape with no sharp edges or corners, which have holes and metal contact bars in place of pins, which are laid out flat on a fabric or other soft material and are sewn onto the fabric or soft material and interconnected with each other with conductive threads, forming a soft hardware module attachable to said clothing or garment accessory.

12. A system comprising:
means for outfitting a user with a wearable computing platform, said outfitting means comprises at least a fabric with an inner surface, an outer surface wherein said wearable computing platform being configured to be integrated in the fabric of the outfitting means, in which said wearable computing platform comprises:
means, incorporated into the outfitting means, for providing power wires, communication wires and connection points;
means for controlling and communicating with at least one or more units of the wearable computing platform;
means, being disposed on a proximate lower sleeve end or upper sleeve of the outfitting in cases where sleeves are presented or front or back portion of the outfitting in cases where sleeves are not presented means and connected to the controlling and communicating means, for sensing a touch of a user and displaying executed software applications;
means for providing power to the sensing and displaying means after being detached from the outfitting means;
means, being disposed on the outfitting means, for supplying power to the controlling and communicating means and the sensing and displaying means; and
means, being operable to control and communicate with at least one or many units of the wearable computing platform, for providing a user interface.

13. The system of claim 12, in which said wearable computing platform further comprising means, being connected to the central processing unit and being disposed on a proximate top portion of the outfitting means, for charging the power providing means or for providing a backup power providing means.

14. The system of claim 12, in which said wearable computing platform further comprising means, being connected to the central processing unit and being disposed on the outfitting means, for adjusting the temperature and humidity inside the outfitting means.

15. The system of claim 12, in which said wearable computing platform further comprising means, being connected to the central processing unit and being disposed on the outfitting means, for two-way radio communication and distress calling.

16. The system of claim 15, in which said two-way radio communication and distress calling means comprises means, being disposed on the outfitting means, for providing a wider coverage of the two-way radio communication and distress calling means.

17. The system of claim 12, in which said wearable computing platform further comprises means, being disposed on the outfitting means, for relaying audio information.

18. The system of claim 12, in which said wearable computing platform means further comprises means, being disposed on the outfitting collar means, for receiving and sending audio information.

19. A system comprising:
a clothing or garment accessory, said clothing or garment accessory comprising at least a fabric with an inner surface and an outer surface being configured to be worn by a user; and
a wearable computing platform that is configured to be integrated with the fabric of the clothing or garment accessory, said wearable computing platform Comprising:
a multiplicity of conductive threads incorporated in the fabric of the clothing or garment accessory, wherein the conductive threads being configured as power wires, communication wires and connection points;
a central processing unit being disposed on the clothing or garment accessory, the central processing unit comprises a non-transitory computer readable medium for storing an operating system and software app or applications, a controller being configured to execute the operating system and the software applications, and a communication module being configured to enable the central processing unit to communicate in a wired or wireless topology, in which the central processing unit is sewn onto a fabric with conductive threads, attached or sewn to the inner or outer surface of the clothing accessory, and covered with insulative layer;
a display unit being disposed on a proximate lower sleeve end, upper sleeve of the clothing or garment accessory in cases where sleeves are presented or front or back portion of the clothing or garment accessory in cases where sleeves are not presented and connected to the central processing unit with the power/communication wires, the display unit comprises a display screen being configured to display the executed software applications, a touch screen overlay on top of the display screen for sensing a touch of a user, a power supply for providing power to the display unit after being detached from the clothing accessory, and a communication module being configured to wired or wirelessly communicate with the central processing unit;
a battery control unit being disposed on a proximate lower end of the clothing or garment accessory, the battery control unit comprising a multiplicity of batteries, being configured to supply power to the central processing unit and the display unit through the power wires and other additional units;
a solar panel unit connected to the battery control unit, the solar panel being configured to charge the batteries in the battery control unit or provide a backup power supply;
a weather control unit connected to the central processing unit, the weather control unit comprises a controller being configured to adjust the temperature and humidity inside the clothing or garment accessory;
a radio unit connected to the central processing unit, the radio unit being configured for two-way radio communication and distress calls;
an object tracking device unit connected to the central processing unit, the object tracking device unit being configured to track or monitor at least one RFID unit attached to an object and trigger an alarm when the RFID unit becomes out of range of a predetermined distance;
a vital sign sensing unit connected to the central processing unit, the vital sign sensing unit being operable for detecting a system user's vital signs; and
wherein a preconfigured software app running on the central processing unit provides a user interface being operable to control and communicate with at least one or more units of the wearable computing platform.

20. The system of claim 19, in which said clothing or garment accessory further comprises at least one of a jacket, a coat, a shirt, a blouse, a T-shirt, a hoodie and a sweatshirt.

21. The system of claim 19, in which said all units in wearable computing platform may comprise a multiplicity of soft hardware modules which comprises a multiplicity of soft chips which are integrated circuits or electronic circuits that are encapsuled in soft material instead of hard material, and formed into relatively flat and smooth shape with no sharp edges or corners, which have holes and metal contact bars in place of pins, which are laid out flat on a fabric or other soft material and are sewn onto the fabric or soft material and interconnected with each other with conductive threads, forming a soft hardware module attachable to said clothing or garment accessory.
